(19) United States
(12) Patent Application Publication
(10) Pub. No.: US 2014/0184502 A1
(43) Pub. Date: Jul. 3, 2014

(54) PORTABLE DEVICE WITH DISPLAY MANAGEMENT BASED ON USER INTENT INTELLIGENCE

(71) Applicant: MIN LIU, Portland, OR (US)

(72) Inventor: MIN LIU, Portland, OR (US)

(21) Appl. No.: 13/727,644

(22) Filed: Dec. 27, 2012

(51) Int. Cl. G06F 3/0346

(52) U.S. Cl. CPC G06F 3/0346
USPC 345/158

(57) ABSTRACT

The claimed subject matter provides a system for enhancing user experience while conserving power in a portable device. The system includes logic to: determine whether a portable electronic device is being held for viewing; and maintain performance of a display of the portable electronic device at least partially in response to a determination that the portable electronic device is being held for viewing.

### TECHNICAL FIELD

One or more embodiments described herein generally relate to portable devices with displays. In particular, the one or more embodiments described herein relate to portable devices with displays that power down after a period of time to conserve power.

### BACKGROUND

Current portable devices, such as phones, game devices, tablets, laptops, and the like, typically rely on battery power to provide power to the display, among other things. To extend battery life on such portable devices, the display will be automatically disabled after a pre-configured inactivity period of time. Activity is typically detected by receipt of input from a user, such as a button being pressed or a finger interacting with a touch screen on the device. However, sometimes a user is viewing content on the display without pressing any buttons or otherwise providing input to the device. Thus, the display will be automatically disabled to conserve power after a period of inactivity and the user's ability to view the content is undesirably disrupted. Accordingly, in such situations user experience is sacrificed for the sake of power savings and the user can experience frustration.

### BRIEF DESCRIPTION OF THE DRAWINGS

FIG. 1 is a schematic showing a user holding a portable device for viewing in accordance with the claimed subject matter;

FIG. 2 is a schematic showing an illustrative portable device with functional blocks representing modules within the portable device in accordance with the claimed subject matter;

FIGS. 3A to 3C is a schematic of a process flow diagram for a method in accordance with a first embodiment in accordance with the claimed subject matter; and

FIGS. 4A to 4D is a schematic of a process flow diagram for a method in accordance with a second embodiment in accordance with the claimed subject matter.

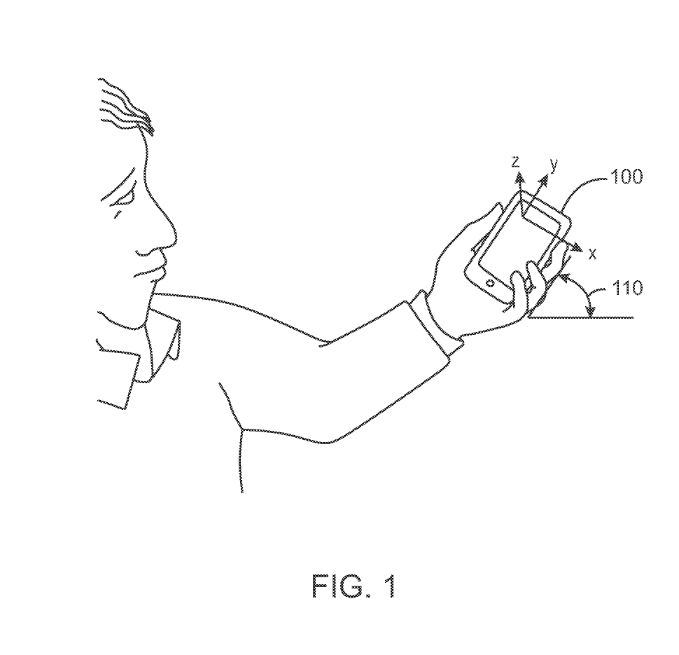

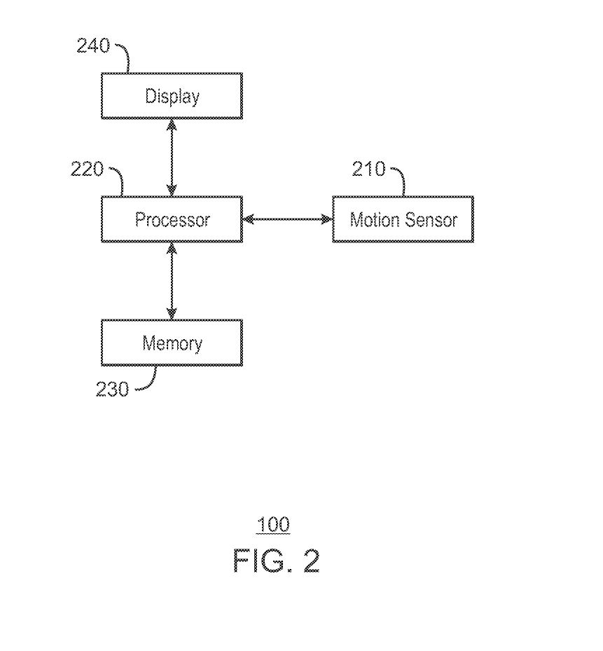

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

In the following description and claims, an embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement or order of features illustrated in the drawings or described herein need not be arranged in the particular way illustrated and described. Many other arrangements are possible according to some embodiments.

In each figure, elements may each have a same reference number or a different reference number to suggest that the elements represented could be different or similar. However, an element may be flexible enough to have different implementations and work with some or all of the systems shown or described herein. The various elements shown in the figures may be the same or different. Which one is referred to as a first element and which is called a second element is arbitrary.

Example embodiments provide systems, apparatuses, and methods for inferring whether a portable device with a display is likely in a state of being held for viewing and maintaining display performance if the user is inferred to likely be viewing the display. Examples of maintaining performance of the display include keeping the display from automatically powering off after an inactivity period, maintaining execution of applications that handle receipt (e.g., via a wireless communication channel), processing, and/or playback of video content; prioritizing execution of applications that handle receipt, processing, and/or playback of video content over other applications or tasks being executed on the portable device including, for example, applications that handle receipt, processing, and/or playback of audio content associated with the video content.

Portable devices with displays include, for example, smart phones, book readers, personal digital assistants (PDAs), laptops, tablets, netbooks, game devices, portable media systems, interface modules, etc. By maintaining display performance while the user is viewing the display and letting the display operate at reduced performance (e.g., automatically power off) otherwise, the user experience is improved without sacrificing battery life and/or wireless data usage.

FIG. 1 is a schematic showing a user holding a portable device 100 (also referred to herein as a “device”) for viewing. When a user holds a portable device to view the content on the device, there are certain common and natural ways the user holds the device. For example, the device is often held so that a viewing surface of a display on the device faces the user and is oriented at an angle 110 that is within a certain range of angles relative to a ground plane. The viewing angle range is, for example, between 20 and 80 degrees. In one embodiment, the viewing angle range is adjustable to different users' usage. The angle 110 of the device can be determined based on motion data, which may be sensed using a motion sensor. The motion sensor may include, for example, a 3-axis accelerometer, which is commonly found in many currently available portable devices. The motion data from the motion sensor can characterize an orientation of the portable device along different axes, denoted in the Figure as x, y, and z axes. In addition, motion of the portable device can be analyzed and classified as corresponding to an action (e.g., holding the portable device for viewing while walking) or a lack of action (e.g., the portable device is stationary). Therefore, in one embodiment described in detail below, motion of the portable device is taken into account in the process of inferring whether the portable device is being held for viewing.

FIG. 2 is a schematic showing an illustrative portable device 100 with functional blocks representing modules within the portable device 100. The portable device 100 includes a motion sensor 210, a processor 220, a memory 230, and a display 240. The motion sensor 210 may be, for example, a gyroscope or an accelerometer. In one embodiment, the motion sensor 210 is a 3-axis accelerometer capable of outputting three motion data measurements (e.g., three acceleration measurements), each measurement corresponding to a different axis (pitch, roll, and yaw). In another embodiment, the motion sensor outputs two motion data measurements corresponding to two axes (e.g., pitch and roll) or, in another embodiment, one motion data measurement corresponding to a single axis (e.g., pitch or roll). Logic in the processor 220 receives the motion data and may calculate other measurements based on the received motion data, including, e.g., a mean acceleration, a deviation or variance from the mean acceleration, and/or a mean deviation. Alternatively, one or more of such calculations may be performed by the motion sensor 210 and the calculation results may be received by the processor 220.

The processor 220 is a general purpose processor that includes logic capable of communicating with the motion sensor 210 via a bus to receive the orientation data and, if applicable, other data. The processor 220 is also capable of communicating with the memory 230 to retrieve executable instructions and data via a dedicated bus. The instructions, when executed, will cause the portable device 100 to perform various operations described herein, such as receiving orientation data from the orientation sensor 210, inferring whether the portable device is likely in a state of being held for viewing based at least partially on the orientation data, and controlling power to the display 240 in dependence on the inferred state. Additionally, the processor 220 can be a single core processor, a multi-core processor, a computing cluster, or any number of other configurations, and can include embedded logic and/or memory. Furthermore, the portable device 100 may include more than one processor 220.

The memory 230 is a storage device that comprises a non-transitory computer-readable medium. The memory 230 stores instructions that are executable by the processor 220 to cause the portable device 100 to perform various operations, including the display power conserving operations described herein. The memory 230 may also control configuration settings, such as a reference inactivity period used by a timer to measure how long to keep the display powered before automatically shutting it off in the absence of user activity.

The display 240 (also referred to herein as a display portion of the device 100) may receive commands and data from the processor 220 to display content (e.g., video, text, images, graphical user interfaces, etc.) to a user of the device 100 via a viewing surface of the display 100 (for simplicity the viewing surface of the display 100 is also referred to herein as the display). As explained above, the display 240 may be shut down or turned off by the processor 220 after a pre-configured inactivity period. Activity that would reset the inactivity period may include, for example, a user pressing a button on the portable device 100 or, if the display 240 is a touchscreen, a user pressing the touchscreen. Moreover, the processor can turn off the display by sending an appropriate command to a power controller of the display, by ceasing to send data to the display 240, or by any other suitable means.

The block diagram of FIG. 2 is not intended to indicate that the computing device 100 is to include all of the components shown in FIG. 2. Further, the portable device 100 may include any number of additional components not shown in FIG. 2, depending on the details of the specific implementation. For example, in addition to the modules shown, the portable device 100 may also include other components and modules (not shown) that carry out functions specific to another use of the portable device, such as various input/output interfaces and devices for interfacing with a user and/or with other computing devices.

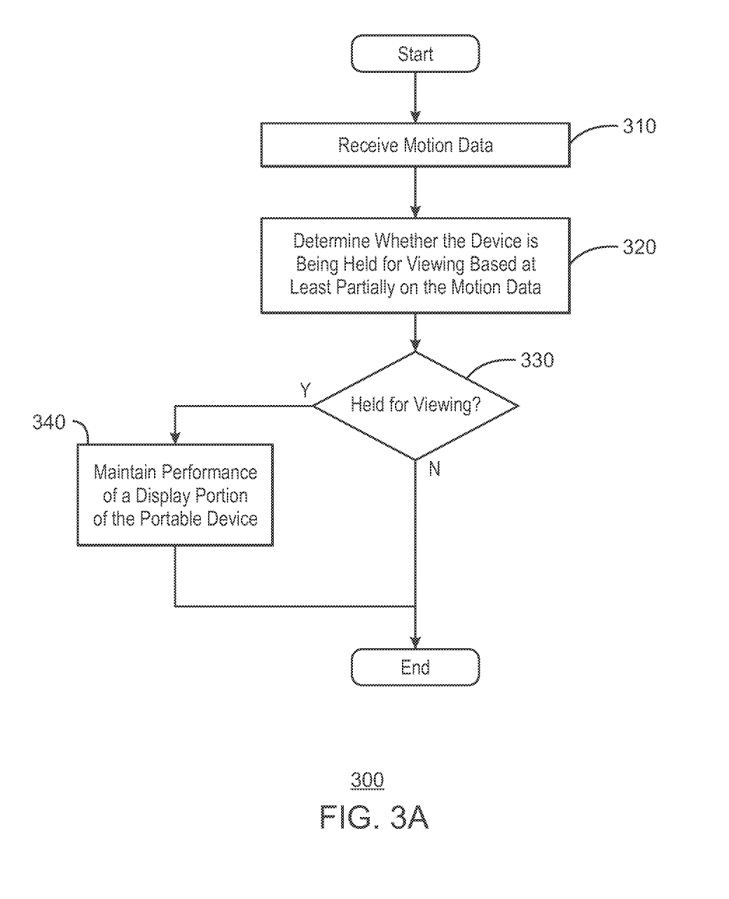

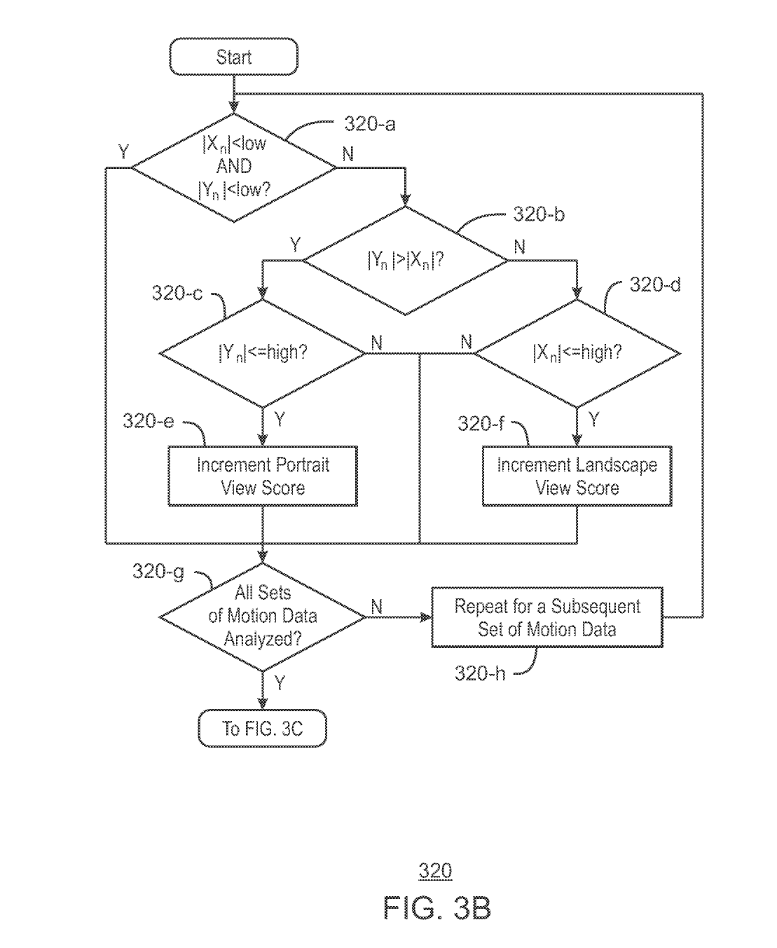

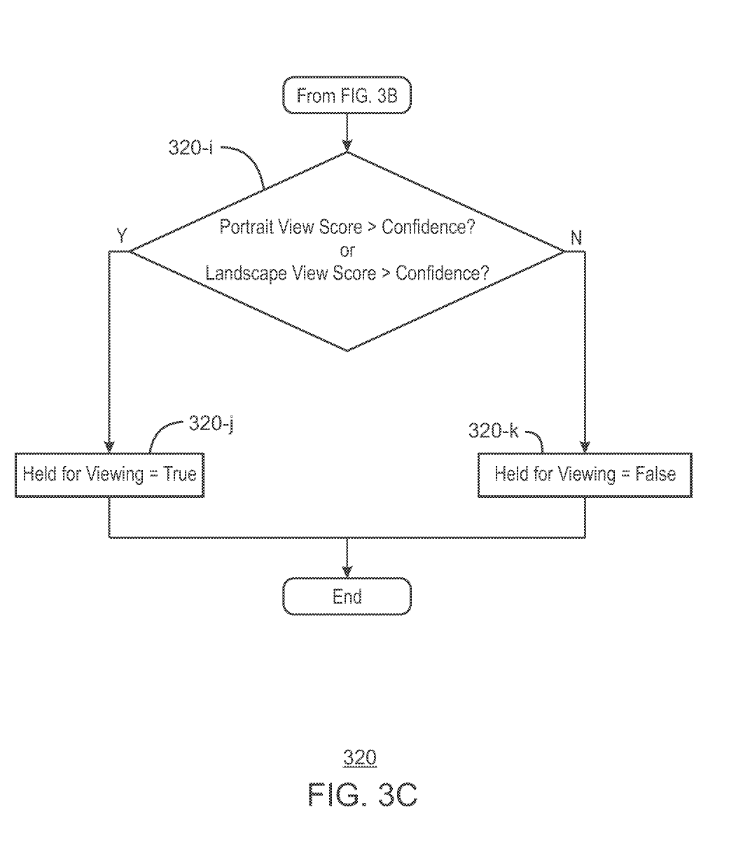

FIGS. 3A to 3C show a schematic of a process flow diagram 300 for a method in accordance with an embodiment. FIG. 3A shows a general view of the process flow diagram 300 and FIGS. 3B and 3C show more detailed views of a specific block in the process flow diagram 300. One or more stages of the method may be implemented, for example, by logic (at least partially including hardware logic) in the processor 220 of the portable device 100. Execution of the method, or portions thereof, may be commenced at least partially in response to an inactivity period reaching or approaching expiration. Alternatively, the method 300, or portions thereof, may be executed on a continual basis at periodic intervals.

Referring to FIG. 3A, at block 310, motion data is received from the motion sensor 210. In one embodiment, the motion data includes one or more sets of motion data samples, each sample of motion data in a set corresponding to a different axis of rotation. Moreover, a plurality of sets of such motion data samples may be gathered over a period of time and used to determine whether the device 100 is being held for viewing. If necessary, the plurality of sets of motion data may be stored in a buffer or register.

At block 320, logic determines whether the device is being held for viewing based at least partially on the motion data. For example, the motion data may indicate (or the logic may derive from the motion data) an angle between a ground plane and an axis that runs along a top to bottom direction of the viewing surface of the display, i.e., a tilt angle. If the tilt angle is between a low threshold (e.g., about 20 degrees) and a high threshold (e.g., about 80 degrees), the device is determined to be held in a tilted orientation for viewing at block 330. In one embodiment, one or both of the low threshold and high threshold are adjustable to accommodate a user's holding preference.

If, at block 330, the device is determined to be held in a tilted orientation for viewing, performance of the display is maintained in response to the determination at block 340. Maintaining performance may include keeping display power on by, for example, resetting an inactivity period timer (e.g., executed by logic in the processor 220). If the device is not determined to be in a state of being held for viewing, the display portion of the device is not prevented from automatically powering off after the pre-configured inactivity period. Maintaining performance of the display may also include maintaining or prioritizing execution of applications that handle receipt (e.g., via a wireless communication channel), processing, and/or playback of video content.

FIGS. 3B and 3C are schematics showing an example process flow diagram for implementing block 320 of the method shown in FIG. 3A in accordance with an embodiment. Because many modern portable devices with displays have portrait and landscape viewing modes, the logic that determines whether the device is being held for viewing may take into account such viewing modes when evaluating the tilt angle at which the display portion of the device is positioned. Thus, as shown in FIG. 3B, two tilt angles—an angle between the ground plane and a first axis (denoted “xₙ”) and an angle between the ground plane and a second axis (denoted “yₙ”), where the first and second axes are axes running along perpendicular edges of the display portion—are compared to each other and to various thresholds to determine whether the device is being held for viewing. The comparisons are made for a sequence of time-consecutive motion data sets and the subscript “n” is an index corresponding to a time-position in the sequence.

Beginning at sub-block 320-a, each of an absolute value of an angle xₙ and an absolute value of an angle yₙ is compared to a first threshold (denoted “low”). (Using absolute values of the angles for comparison, rather than non-absolute values, accounts for the ability many modern displays have to reconfigure the display orientation based on the orientation of the device relative to the ground and accounts for the possibility of a user who is lying down with the display facing downward.) If either of the angle values is not lower than the first threshold—indicating that the device is being held with the display at an angle relative to the ground plane that is greater than the first threshold—the method proceeds to sub-block 320-b and the angle values are compared to each other to determine whether the display is being held in a portrait view mode or a landscape view mode.

The method proceeds to either sub-block 320-c or sub-block 320-d, depending on which viewing mode the display is in, to determine whether the larger of the two angle values is less than a second threshold (denoted “high”). The first threshold may be, for example, about 20 degrees and the second threshold may be, for example, about 80 degrees. If the angle value is between the two thresholds a score corresponding to the appropriate viewing mode is incremented at one of sub-blocks 320-e and 320-f. If both angle values are below the low threshold this indicates that a viewing surface of the display portion is being held in a substantially flat (i.e., parallel to the ground plane) orientation, which is not a normal viewing orientation, and the method proceeds to sub-block 320-g to determine if all sets of motion data in a pre-determined time period have been analyzed and neither the portrait view score nor the landscape view score is incremented for that set of motion data. In one embodiment, the pre-determined time period to which the sets of motion data correspond is a period of about one second, which may correspond to about 16 sets of motion data, and the pre-determined time period may be user-configurable or adaptively configurable. Similarly, if the larger of the two angle values is higher than the high threshold and if the high threshold is smaller than 90 degrees, this indicates that the viewing surface of the display portion is being held in an orientation that is substantially perpendicular to the ground plane, which is not a normal viewing orientation. Accordingly, the method proceeds to sub-block 320-g without incrementing either the portrait view or the landscape view scores. Certain users, however, may prefer holding the device vertically for viewing and may therefore opt to set the high threshold to 90 degrees, resulting in a score corresponding to the appropriate viewing mode (landscape or portrait) being incremented at one of sub-blocks 320-e and 320-f when at least one of the angle values is above the low threshold. If not all sets of motion data have been analyzed the method repeats for a subsequent set of motion data, as indicated by sub-block 320-h.

Referring now to FIG. 3C, if all sets of motion data in the pre-determined time period have been analyzed the method proceeds to sub-block 320-i where the portrait view and landscape view scores are compared to a confidence level or threshold. Alternatively, to account for different time periods over which the sets of motion data are analyzed, the scores are averaged before being compared to a confidence level. In one embodiment, the confidence level to which the average score is compared is 80%. If either score is high enough, the device is determined to be held for viewing at sub-block 320-j. Otherwise, at sub-block 320-k, the device is determined not be held for viewing and, consequently, performance of the display portion of the device is maintained.

In the foregoing description, absolute values of angles xₙ and yₙ (|xₙ| and |Yₙ|) are used to determine whether the device is being held for viewing. However, in one embodiment, the real values of xₙ and yₙ, or a combination of real values and absolute values, may be used instead. Moreover, the comparison operations in sub-blocks 320-a, 320-b, 320-c, and/or 320-d may be modified as appropriate to account for the use of real values instead of absolute values.

For example, in one embodiment, the real value of yₙ may be used instead of the absolute value, |yₙ|, if the portable device has only one allowable portrait orientation that aligns to the positive y axis. In another embodiment, the absolute value, |Yₙ|, may be used in block 320-a but the real value of yₙ may be used in blocks 320-b and 320-c, with appropriate adjustment of the process flow diagram.

Furthermore, for portable devices in which only one landscape orientation is allowed, e.g., one that aligns to the positive x axis, the real value of xₙ may be instead of the absolute value, |xₙ|, or a combination of the real value and absolute value of xₙ may be used, with appropriate adjustment of the process flow diagram.

Moreover, in one embodiment, raw sensor data, for example linear acceleration data output by an accelerometer, can be used as a proxy for a tilt angle and an accurate tilt need angle need not be calculated. If raw sensor data is used, the viewing angle range defined by the low and high threshold values are appropriately adjusted. For example, when using an accelerometer's raw sensor data, the viewing angle range can be defined as corresponding to a sensor output range between 2 m/s² and 9.8 m/s².

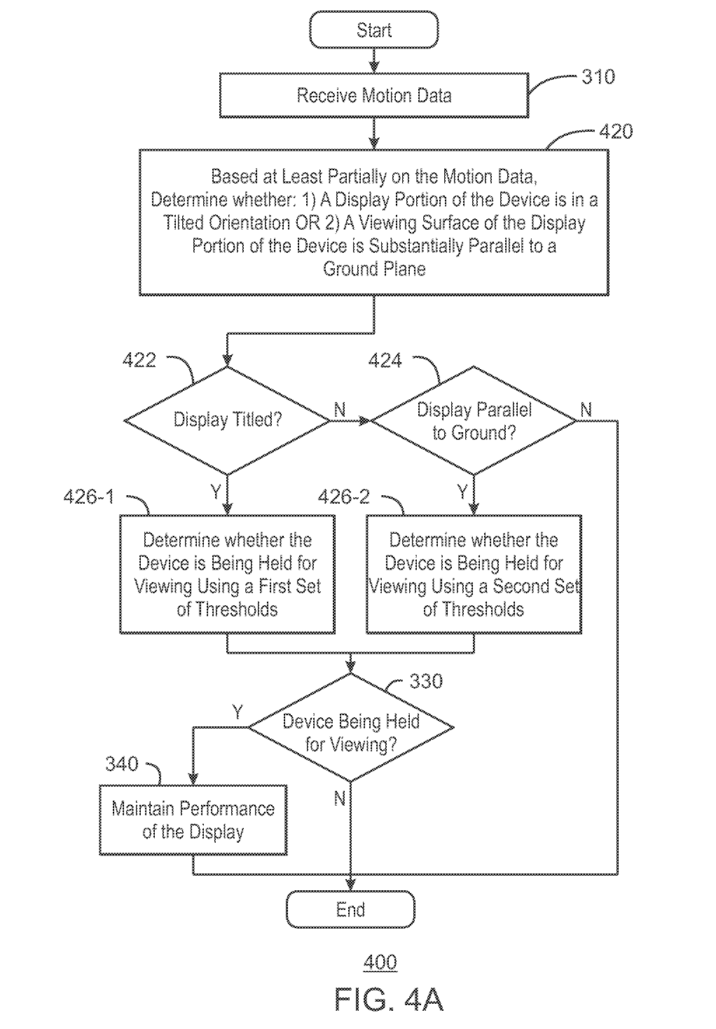

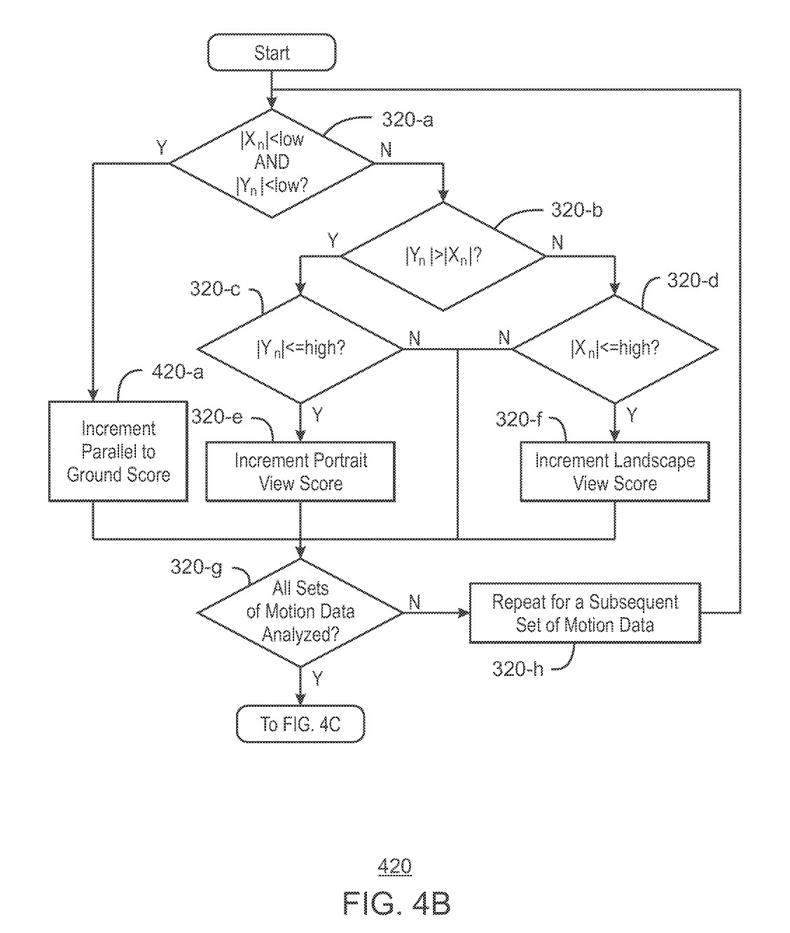

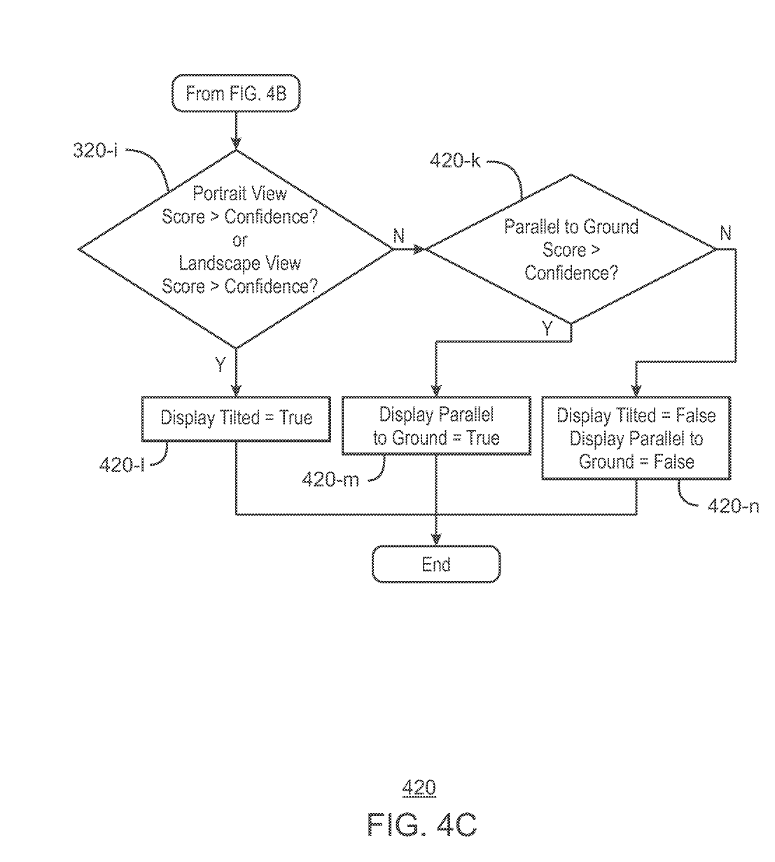

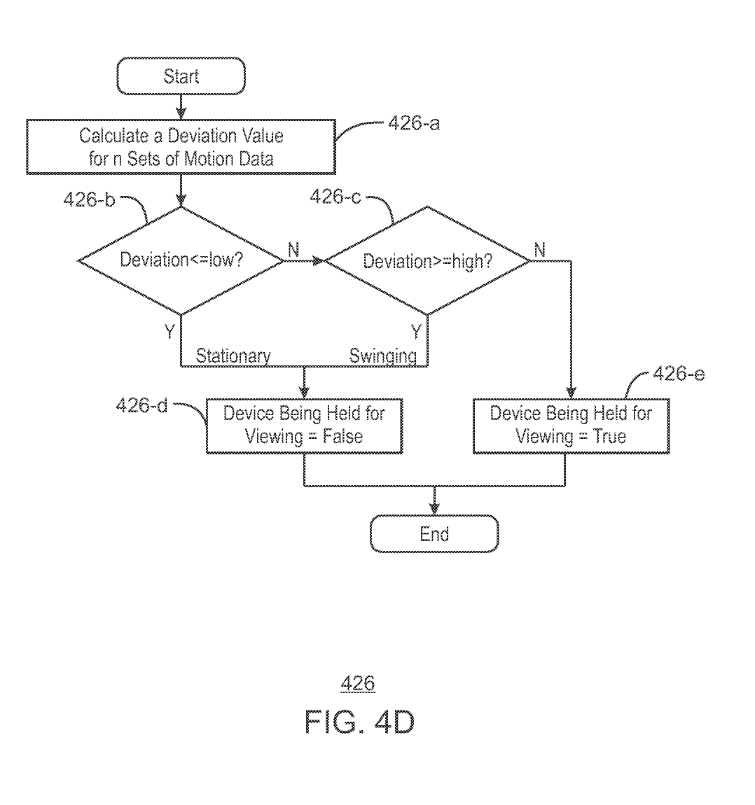

FIGS. 4A to 4D show a schematic of a process flow diagram 400 for a method in accordance with a second embodiment. The method of FIGS. 4A to 4D (i.e., the second method) accounts for certain use cases that the method of FIGS. 3A to 3C (i.e., the first method) does not adequately account for. For example, a user who is walking while viewing the display of a portable device will commonly hold the device in a flat or parallel to the ground viewing orientation, which the first method would classify as not being held for viewing. Moreover, if the user is walking and swinging the device, the first method might classify the device as being held for viewing because the device will often be maintained at a tilted angle in such a scenario. Thus, additional analysis of the motion data may be performed in the second method.

Referring to FIG. 4A, in the first block 310, the motion data is received as described above with reference to FIG. 3A. Then, at blocks 420, 422, and 424, logic determines, based at least partially on the motion data, if either of two conditions are satisfied, namely, whether: 1) whether a display portion of of the device is in a tilted orientation, or 2) a plane defined by the display portion of the device is substantially parallel to a ground plane. (A more detailed description of block 420 is provided below with reference to FIGS. 4B and 4C.) If the first condition is satisfied, i.e., the display is tilted (block 422), logic determines whether the device is being held for viewing using a first set of thresholds at block 426-1. If the second condition is satisfied, i.e., the display is parallel to the ground (block 424), logic determines whether the device is being held for viewing using a second set of thresholds at block 426-2. If neither condition is satisfied, the device is determined not be held for viewing and, consequently, performance of the display portion of the device is not maintained (e.g., the display is not prevented from being automatically powered off after the inactivity period expires). Moreover, if the device is determined not to be held for viewing at either of blocks 426-1 or 426-2, the same condition results. Otherwise, if the device is determined to be held for viewing at either of blocks 426-1 or 426-2, display performance is maintained at least partially in response to the determination. For example, an inactivity period timer is reset.

FIGS. 4B and 4C show an example process flow diagram for implementing block 420 of the method shown in FIG. 4A in accordance with an embodiment. Many of the sub-blocks in the process flow diagram of FIGS. 4B and 4C correspond in function to (and are referenced using the same reference number as) sub-blocks in the process flow diagram for implementing block 320, shown in FIGS. 3A to 3C. A first difference between the implementation of block 420 and block 320, however, is that, in addition to determining when a tilt angle corresponds to a portrait or landscape view and incrementing a corresponding score, block 420 also includes a sub-block 420-a to increment a parallel to ground score if the display is determined to be at an angle that is substantially parallel to the ground, i.e., in a flat orientation.

Moreover, a second difference between the implementations of block 420 and block 320 is that instead of determining that the display is being held for viewing or not based on the portrait and landscape view scores, the method of block 420 determines whether the display is in a tilted orientation relative to the ground or a substantially parallel to the ground orientation. For example, with reference to FIG. 4C, at sub-block 320-i the display is determined to be in a tilted orientation if the portrait view score or landscape view score is greater than a confidence threshold. If neither score is high enough, the parallel to ground score is compared with a corresponding confidence threshold at sub-block 420-k. If the parallel to ground score is high enough the display is determined to be in a substantially parallel to ground orientation. If not, the display is determined not to be in either a substantially parallel to ground orientation or a tilted orientation. This may be the case if, for example, the display is tilted in various different directions over the observation period or if the display is held substantially perpendicular to the ground.

Referring again to FIG. 4A, after block 420, the method of the process flow diagram 400 proceeds to block 426-1, block 426-2, or ends, depending on the conclusion reached at sub-blocks 320-i and 420-k of FIG. 4C. If the display is determined to be tilted the method proceeds to block 426-1, if the display is determined to be substantially parallel to the ground the method proceeds to block 426-2, and the method ends if the display is not found to be in either orientation.

FIG. 4D shows an example process flow diagram for implementing block 426 of the method shown in FIG. 4A in accordance with an embodiment. Block 426, explained in more detail below, determines degrees of motion experienced by the device based at least partially on the received motion data. Block 426 is a generalization of blocks 426-1 and 426-2—a different “low” threshold is used for block 426-1 than for block 426-2. Otherwise, the functions carried out by each of blocks 426-1 and 426-2 are the same and each is therefore represented by the process flow diagram of FIG. 4D.

First at sub-block 426-a of FIG. 4D, a deviation value is calculated for a pre-determined number of sets of motion data. The sets of motion data may be the same as the sets used in block 420 to determine an orientation of the display. The deviation value may be, for example, a statistically calculated standard deviation value or may be a mean deviation value that is a mean deviation from a mean of the motion values in the set of motion data. Next, at sub-block 426-b, the deviation value is compared to a low threshold level. If the deviation is less than or equal to the low threshold, the device is determined to be in a stationary state, meaning it is not being held for viewing, at sub-block 426-d. If the device is resting on a table, for example, it will be determined to be in a stationary state. However, if the table is not stable and/or if someone walks by shaking the ground, the movement may be transferred to the device. Therefore, to avoid falsely detecting such motion as corresponding to a state of being held for viewing, the low threshold may be set higher for implementation of block 426-2 (i.e., when the display is determined to be parallel to ground) than for implementation of block 426-1 (i.e., when the display is determined to be in a tilted orientation relative to the ground). In an alternative embodiment, however, the same low threshold may be applied for both cases.

If the deviation value is greater than the low threshold, the deviation value is compared to a high threshold level at sub-block 426-c. If the deviation value is greater than or equal to the high threshold value the device is determined to be in a swinging or high motion state, meaning it is not being held for viewing, at sub-block 426-d. Consequently, performance of the display portion of the device is not maintained (e.g., the display portion is not prevented from being automatically powered off after the inactivity period expires. Otherwise, if the deviation value is somewhere between the low and high thresholds, the device is determined to be in a state of being held for viewing at sub-block 426-e. Consequently, performance of the display portion of the device is maintained (e.g., the display is prevented from being automatically powered off after the inactivity period expires).

The process flow diagrams 300 and 400 are provided by way of example and not limitation. More specifically, additional blocks or flow diagram stages may be added and/or at least one of the blocks or stages may be modified or omitted. Moreover, certain block may be implemented in a different order than the order shown. For example, instead of comparing a value (e.g., an angle or deviation value) to a low threshold and then a high threshold, the value may be compared to the high threshold first, or both comparisons may be made simultaneously.

Embodiments of the invention are not restricted to the particular details listed herein. Indeed, those skilled in the art having the benefit of this disclosure will appreciate that many other variations from the foregoing description and drawings may be made within the scope of the present inventions. For example, in addition or as an alternative to using motion data to determine whether the device 100 is being held for viewing, additional types of data may be used. In one example embodiment, a light sensor on the device detects an amount of light received and, if the light is below a predetermined threshold, the device is determined to be in a pocket, pouch, purse, or the like, and the display is powered off to conserve power regardless of what motion data is being received. Accordingly, it is the following claims including any amendments thereto that define the scope of the inventions.

What is claimed is:

1. An apparatus to enhance user experience comprising:
logic, the logic at least partially including hardware logic, to:
determine whether a portable electronic device is being held for viewing; and
maintain performance of a display of the portable electronic device at least partially in response to a determination that the portable electronic device is being held for viewing.

2. The apparatus of claim 1, wherein the logic is to determine whether the portable electronic device is being held for viewing at least partially in response to expiration of an inactivity period timer.

3. The apparatus of claim 2, wherein the logic is to restart the inactivity period timer at least partially in response to a determination that the portable electronic device is being held for viewing.

4. The apparatus of claim 1, wherein the logic is to determine whether the display of the portable electronic device is in a tilted orientation to determine whether the portable electronic device is being held for viewing.

5. The apparatus of claim 1, wherein the logic is to determine whether a viewing surface of the display of the portable electronic device is substantially parallel to a ground plane to determine whether the portable electronic device is being held for viewing.

6. The apparatus of claim 1, wherein the logic is to receive motion data associated with the portable electronic device and to determine whether the portable electronic device is being held for viewing based at least partially on the motion data.

7. The apparatus of claim 6, wherein the motion data characterizes a tilt angle at which the display of the portable electronic device is positioned, and wherein the logic is to determine whether the tilt angle is between a first threshold and a second threshold to determine whether the portable electronic device is being held for viewing.

8. The apparatus of claim 6, wherein the logic is to classify degrees of motion based at least partially on the motion data to determine whether the portable electronic device is being held for viewing.

9. The apparatus of claim 6, wherein the logic is to determine a deviation value for the motion data, and wherein the logic is to determine whether the deviation value is between a first threshold and a second threshold to determine whether the portable electronic device is being held for viewing.

10. The apparatus of claim 6, wherein the logic is to receive motion data corresponding to signals from at least one of an accelerometer and a gyroscope.

11. One or more non-transitory computer readable media having instructions that, when executed by one or more processors of a portable electronic device, cause the portable electronic device to perform operations comprising:
determine whether the portable electronic device is being held for viewing; and
maintain performance of a display of the portable electronic device at least partially in response to a determination that the portable electronic device is being held for viewing.

12. The one or more non-transitory computer readable media of claim 11, wherein a determination of whether the portable electronic device is being held for viewing is made at least partially in response to expiration of an inactivity period timer.

13. The one or more non-transitory computer readable media of claim 12, wherein the operations further include:
restart the inactivity period timer at least partially in response to a determination that the portable electronic device is being held for viewing.

14. The one or more non-transitory computer readable media of claim 11, wherein the operations further include:
determine whether the display of the portable electronic device is in a tilted orientation to determine whether the portable electronic device is being held for viewing.

15. The one or more non-transitory computer readable media of claim 11, wherein the operations further include:
determine whether a viewing surface of the display of the portable electronic device is substantially parallel to a ground plane to determine whether the portable electronic device is being held for viewing.

16. The one or more non-transitory computer readable media of claim 11, wherein the operations further include:
receive motion data associated with the portable electronic device, and
wherein a determination of whether the portable electronic device is being held for viewing is made based at least partially on the motion data.

17. The one or more non-transitory computer readable media of claim 16, wherein the motion data characterizes a tilt angle at which the display of the portable electronic device is positioned, and wherein the operations further include:
determine whether the tilt angle is between a first threshold and a second threshold to determine whether the portable electronic device is being held for viewing.

18. The one or more non-transitory computer readable media of claim 16, wherein the operations further include:
classify degrees of motion based at least partially on the motion data to determine whether the portable electronic device is being held for viewing.

19. The one or more non-transitory computer readable media of claim 16, wherein the operations further include:
determine a deviation value for the motion data, and
determine whether the deviation value is between a first threshold and a second threshold to determine whether the portable electronic device is being held for viewing.

20. The one or more non-transitory computer readable media of claim 16, wherein the received motion data corresponds to signals from at least one of an accelerometer and a gyroscope.

21. A portable electronic device comprising:
a display;
one or more motion sensors;
logic, the logic at least partially including hardware logic, to:
determine whether the portable electronic device is being held for viewing; and
maintain performance of the display of the portable electronic device at least partially in response to a determination that the portable electronic device is being held for viewing.

22. The portable electronic device of claim 21, wherein the one or more motion sensors include at least one of an accelerometer and a gyroscope.
